(19) United States
(12) Patent Application Publication
(10) Pub. No.: US 2008/0306776 A1
(43) Pub. Date: Dec. 11, 2008

(54) SYSTEM AND METHOD FOR RISK ACCEPTANCE IN THE PROVISIONING OF PRICE PROTECTION PRODUCTS

(75) Inventors: Robert M. Fell, Summerland, CA (US); Scott Painter, Bel Air, CA (US); Michael R. Bonsignore, Seattle, WA (US); Brian P. Reed, Southlake, TX (US); Gary A. Magnuson, Corpus Christi, TX (US)

Correspondence Address: SPRINKLE IP LAW GROUP, 1301 W. 25TH STREET, SUITE 408, AUSTIN, TX, 78705, US

(73) Assignee: Pricelock, Inc., Irving, TX (US)

(21) Appl. No.: 12/099,209

(22) Filed: Apr. 8, 2008

Related U.S. Application Data
(60) Provisional application No. 60/922,521, filed on Apr. 9, 2007.

(51) Int. Cl. G06Q 40/00

(52) U.S. Cl. 705/4; 705/35

(57) ABSTRACT

A provider of price protection products may enter into an agreement with a set of terms and associated financial risk with a financial institution such that the financial institution provides indemnification against the financial risk associated with selling a commodity. The provider may analyze data, the terms of the agreement and perform scenario analyses to determine its financial risk and may lay off or take on more risk. The provider may offer price protection products to consumers via computing devices and retail locations. The products may have the same terms as the agreement between the provider and the financial institution, or may have different terms and conditions to either take on or lay off risk.

### RELATED INFORMATION

This application claims priority to U.S. Provisional Patent Application No. 60/922,5217 entitled “System and Method for Risk Acceptance in the Provisioning of Price Protection Contracts,” filed on Apr. 9, 2007, by Fell et al. This application relates to U.S. patent application Ser. No. 11/705,571, entitled “Method and System for Providing Price Protection for Commodity Purchasing Through Price Protection Contracts,” filed on Feb. 12, 2007, by Fell et al. Both of these applications are incorporated herein as if set forth in full.

### FIELD OF THE INVENTION

This invention relates generally to systems and methods for commodity purchasing, and in particular to systems and methods for commodity purchasing which allow consumers to protect against variability in the market for a commodity. Even more particularly, embodiments of the present invention relate to systems and methods for accepting risk in the provisioning of products which allow a consumer to obtain protection against adverse fluctuations in the price of a commodity.

### BACKGROUND

Many individual consumers and businesses desire to financially protect themselves from potential increases in the price of a commodity to not only lower costs for themselves but, additionally, to create greater predictability in future costs for that commodity. For example, as the price of oil continues to fluctuate, fuel prices at the pump can change from location to location on a daily or even hourly basis.

### SUMMARY

In a volatile market, a consumer or business may desire to protect themselves against adverse fluctuations in the cost of a commodity. Thus, a provider of price protection may allow a consumer to obtain a price protection product such that a consumer may be protected against adverse price fluctuations in the cost of that commodity. The provider of such price protection products may accept risk in conjunction with provisioning of the price protection products based on the risk aversion of the provider. Within this disclosure, risk acceptance refers to taking, absorbing or laying off the risk associated with providing a price protection product.

Embodiments of systems and methods for the acceptance of risk in conjunction with the provisioning of price protection products to a consumer are disclosed. While these price protection products may pertain to almost any type of commodity, embodiments disclosed herein may pertain especially well to systems and method for allowing a consumer to obtain price protection on the purchase of carbon-based energy products such as motor fuel, diesel fuel, heating oil, aviation fuel and carbon-offsets. Specifically, embodiments of the present invention may allow a provider of price protection products to accept risk in the provisioning of a price protection product to a consumer where the provider of the price protection product may obtain indemnification from an insurance provider. More particularly, in one embodiment, a provider of price protection products may establish an agreement with a financial institution or other insurer having a first set of terms under which the provider of price protection products may obtain indemnification from the insurer. The providers of price protection products may provide a particular price protection product to a consumer based on the terms offered in the agreement provided by the insurer, where the terms of the provided price protection product may be different than those obtained from the insurer in conjunction with the provisioning of the price protection agreement, or where additional or fewer conditions are provided in conjunction with the provisioning of the price protection product. By providing a price protection product having different terms from those in an agreement offered by an insurer, the providers of the price protection product may accept more or less financial risk relative to the indemnification obtained from the insurer in conjunction with the provisioning of the price protection product to the consumer.

Embodiments disclosed herein may provide a product for price protection which may protect a consumer against adverse fluctuations while still allowing the consumer to take advantage of any beneficial fluctuations that occur in the market price. Such a price protection product may allow a consumer to purchase a commodity at a lock price if an index price of the fuel at the time of purchase is above the lock price, yet allowing the consumer to purchase the commodity at the prevailing retail price if the index price or the prevailing retail price of the commodity at the time of purchase is below the lock price. In other words, if the index price or prevailing retail price of fuel at the time of the purchase is below the lock price, the consumer may purchase the commodity at the then prevailing retail price and the cost of the purchase may be paid via some alternate payment method, such as a credit card. If, however, the index price of the commodity at the time of a purchase is above the lock price associated with the price protection product, the commodity may be purchased at the lock price by the consumer. The costs associated with the purchase transaction may be settled with respect to the index price. If the retail price at the retail point of sale location is above the index price at the time of purchase, the consumer (or someone else) may be responsible for any difference between the prevailing retail price at the point of sale retail location where the commodity was purchased and the index price. As such, the consumer may be protected for any difference between the lock price and the index price and be responsible for any difference between the retail price and the index price. If the prevailing retail price at the point of sale retail location where the commodity was purchased is below the index price at the time of purchase the difference between the prevailing retail price and the index price may accrue to the benefit of the consumer, the operators of a price protection system, some other entity, or a combination thereof.

These, and other, aspects will be better appreciated and understood when considered in conjunction with the following description and the accompanying drawings. The following description, while indicating various embodiments and numerous specific details thereof, is given by way of illustration and not of limitation. Many substitutions, modifications, additions or rearrangements may be made within the scope of the disclosure, and the disclosure includes all such substitutions, modifications, additions or rearrangements.

### BRIEF DESCRIPTION OF THE DRAWINGS

Advantages of the present invention will become apparent to those skilled in the art with the benefit of the following detailed description and upon reference to the accompanying drawings in which:

FIG. 1 depicts a block diagram illustrating one embodiment of a system for providing price protection products to consumers;

FIG. 2 depicts a flow diagram illustrating one embodiment of a method for providing price protection products to a consumer; and

FIG. 3 depicts a flow diagram illustrating one embodiment of a method for determining financial risk for a commodity.

### DETAILED DESCRIPTION

The invention and the various features and advantageous details thereof are explained more fully with reference to the non-limiting embodiments that are illustrated in the accompanying drawings and detailed in the following description. Descriptions of well known starting materials, processing techniques, components and equipment are omitted so as not to unnecessarily obscure the disclosure in detail. Skilled artisans should understand, however, that the detailed description and the specific examples, while disclosing preferred embodiments, are given by way of illustration only and not by way of limitation. Various substitutions, modifications, additions or rearrangements within the scope of the underlying inventive concept(s) will become apparent to those skilled in the art after reading this disclosure.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized encompass other embodiments as well as implementations and adaptations thereof which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment,” and the like.

Before discussing specific embodiments, an exemplary hardware architecture for implementing embodiments of the present invention will now be described. Specifically, one embodiment of the present invention can include a computer communicatively coupled to a network. The Internet is an example of a network. As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (e.g., mouse, trackball, stylist, etc.), or the like. In embodiments of the invention, the computer has access to at least one database over the network.

ROM, RAM, and HD are computer memories for storing computer-executable instructions executable by the CPU. Within this disclosure, the term “computer-readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium such as a hard drive. Alternatively, the computer-executable instructions may be stored as software code components on a DASD array, magnetic tape, floppy diskette, optical storage device, or other appropriate computer-readable medium or storage device.

In one exemplary embodiment of the invention, the computer-executable instructions may be lines of complied C++, Java, HTML, or any other programming or scripting code. Other software/hardware/network architectures may be used. For example, the functions of the present invention may be implemented on one computer or shared among two or more computers. In one embodiment, the functions of the present invention may be distributed in the network. Communications between computers implementing embodiments of the invention can be accomplished using any electronic, optical, radio frequency signals, or other suitable methods and tools of communication in compliance with known network protocols.

Reference is now made in detail to the exemplary embodiments, examples of which are illustrated in the accompanying drawings. Wherever possible, the same reference numbers will be used throughout the drawings to refer to the same or like parts (elements).

Within this disclosure, the term “commodity” refers to an article of commerce—an item that can be bought and sold freely on a market. It may be a product which trades on a commodity exchange or spot market and which may fall into one of several categories, including energy, food, grains, and metals. Currently, commodities that can be traded on a commodity exchange include, but are not limited to, crude oil, light crude oil, natural gas, heating oil, gasoline, propane, ethanol, electricity, uranium, lean hogs, pork bellies, live cattle, feeder cattle, wheat, corn, soybeans, oats, rice, cocoa, coffee, cotton, sugar, gold, silver, platinum, copper, lead, zinc, tin, aluminum, titanium, nickel, steel, rubber, wool, polypropylene, and so on. Note that a commodity can refer to tangible things as well as more ephemeral products. Foreign currencies and financial indexes are examples of the latter. For example, positions in the Goldman Sachs Commodity Index (GSCI) and the Reuters Jefferies Consumer Research Board Index (RJCRB Index) can be traded as a commodity. What matters is that something be exchanged for the thing New York Mercantile Exchange (NYMEX) and Chicago Mercantile Exchange (CME) are examples of a commodity exchange. Other commodities exchanges also exist and are known to those skilled in the art.

In a simplified sense, commodities are goods or products with relative homogeneousness that have value and that are produced in large quantities by many different producers; the goods or products from each different producer are considered equivalent. Commoditization occurs as a goods or products market loses differentiation across its supply base. As such, items that used to carry premium margins for market participants have become commodities, of which crude oil is an example. However, a commodity generally has a definable quality or meets a standard so that all parties trading in the market will know what is being traded. In the case of crude oil, each of the hundreds of grades of fuel oil may be defined. For example, West Texas Intermediate (WTI), North Sea Brent Crude, etc. refer to grades of crude oil that meet selected standards such as sulfur content, specific gravity, etc., so that all parties involved in trading crude oil know the qualities of the crude oil being traded. Motor fuels such as gasoline represent examples of energy-related commodities that may meet standardized definitions. Thus, gasoline with an octane grade of 87 may be a commodity and gasoline with an octane grade of 93 may also be a commodity, and they may demand different prices because the two are not identical—even though they may be related. Those skilled in the art will appreciate that other commodities may have other ways to define a quality. Other energy-related commodities that may have a definable quality or that meet a standard include, but are not limited to, diesel fuel, heating oils, aviation fuel, and emission credits. Diesel fuels may generally be classified according to seven grades based in part on sulfur content, emission credits may be classified based on sulfur or carbon content, etc.

Historically, risk is the reason exchange trading of commodities began. For example, because a farmer does not know what the selling price will be for his crop, he risks the margin between the cost of producing the crop and the price he achieves in the market. In some cases, investors can buy or sell commodities in bulk through futures contracts. The price of a commodity is subject to supply and demand.

A commodity may refer to a retail commodity that can be purchased by a consuming public and not necessarily the wholesale market only. One skilled in the art will recognize that embodiments disclosed herein may provide means and mechanisms through which commodities that currently can only be traded on the wholesale level may be made available to retail level for retail consumption by the public. One way to achieve this is to bring technologies that were once the private reserves of the major trading houses and global energy firms down to the consumer level and provide tools that are applicable and useful to the retail consumer so they can mitigate and/or manage their measurable risks involved in buying/selling their commodities. One example of an energy related retail commodity is motor fuels, which may include various grades of gasoline. For example, motor fuels may include 87 octane grade gasoline, 93 octane grade gasoline, etc as well as various grades of diesel fuels. Other examples of an energy related retail commodity could be jet fuel, heating oils, electricity or emission credits such as carbon offsets. Other retail commodities are possible and/or anticipated.

While a retail commodity and a wholesale commodity may refer to the same underlying good, they are associated with risks that can be measured and handled differently. One reason is that, while wholesale commodities generally involve sales of large quantities, retail commodities may involve much smaller transaction volumes and relate much more closely to how and where a good is consumed. The risks associated with a retail commodity therefore may be affected by local supply and demand and perhaps different factors. Within the context of this disclosure, there is a definable relationship between a retail commodity and the exposure of risks to the consumer. This retail level of the exposure of risks may correlate to the size and the specificity of the transaction in which the retail commodity is traded. Other factors may include the granularity of the geographic market where the transaction takes place, and so on. For example, the demand for heating oil No. 2 in January may be significantly different in the Boston market than in the Miami market.

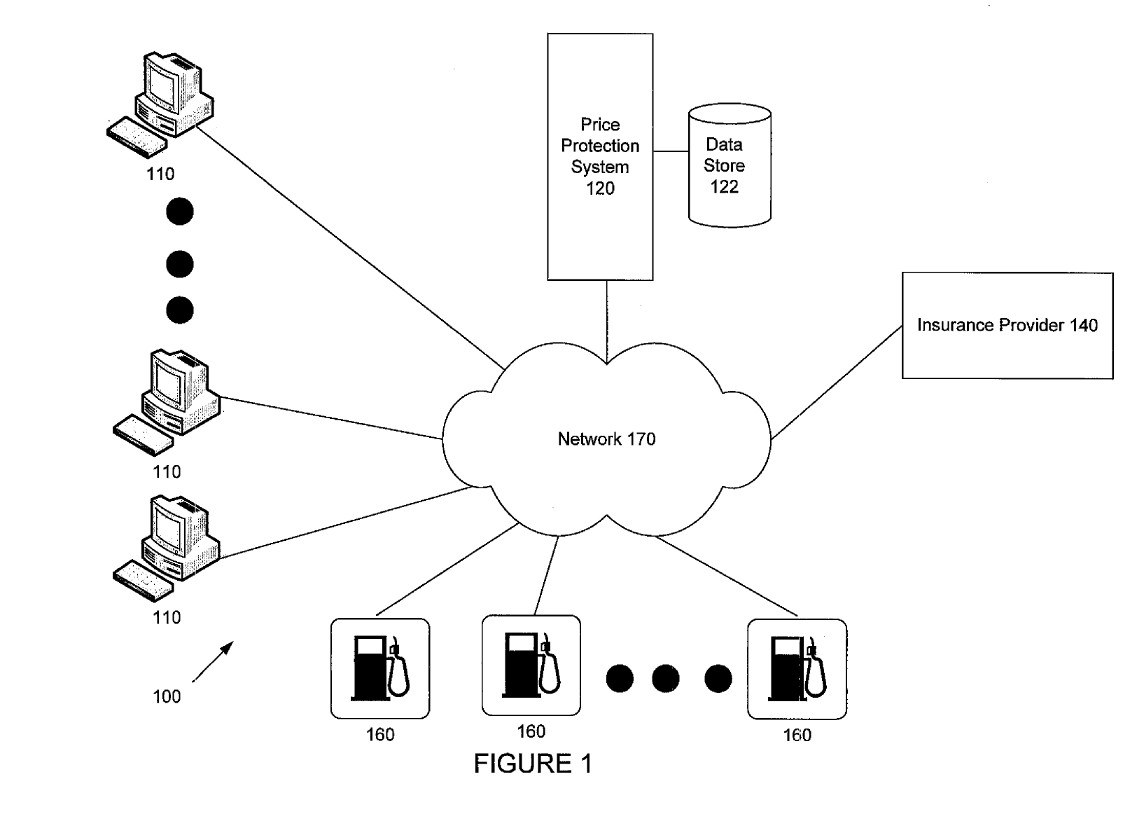

Embodiments of the systems and methods disclosed herein may be better explained with reference to FIG. 1 which depicts one embodiment of a topology which may be used in conjunction with the systems and methods of the present invention. Topology 100 comprises price protection system 120 (also referred to, in some embodiments, as provider 120) which may be coupled through network 170 to consumers 110 via computing devices such as computer systems, personal data assistants, kiosks, dedicated terminals, etc., financial institution 140 (also referred to, in some embodiments, as insurer 140), and one or more associated retail point-of-sale locations 160. Price protection system 120 may include data store 122.

Consumers 110 may desire price protection products for various commodities. In a carbon-based energy setting, consumers 110 may desire price protection against the cost of motor fuels, heating oil, diesel fuels, aviation fuels, carbon offsets, etc. A fleet manager may want price protection products for diesel fuel for a fleet of vehicles operating in a multi-state area. An apartment manager may want price protection for heating oil for several buildings. A car owner may want a price protection product for gasoline for a single vehicle. Consumer 110 may provide information about miles driven, type of fuel needed, etc. to provider 120.

Insurer 140 may be a financial institution such as a bank, an investment firm, or an insurance company. Insurer 140 may determine a financial risk for providing price protection for a commodity. Insurer 140 may develop a price protection matrix for a commodity with financial risks associated with different levels, grades, or types of the commodity. As an example relating to motor fuels, a price protection matrix may determine a financial risk associated with 87 unleaded gasoline and 93 unleaded gasoline. The financial risks may differ between the grades of gasoline.

Provider 120 may establish an agreement with insurance provider 140 such that insurance provider 140 promises to indemnify provider 120 against the retail cost of a commodity exceeding an insurance strike price in exchange for an associated insurance cost per unit of commodity for a Designated Market Area (DMA). By provider 120 paying the insurance cost to insurer 140, provider 120 can be indemnified for a cost of the commodity purchased within the DMA above the insurance strike price.

Provider 120 may analyze data related to the commodity to determine a financial risk associated with a price protection product. The analysis may include historical analyses, such as how an index price has fluctuated in recent months, how pump prices have changed in response to local, regional and global events, how closely pump prices in outlying areas have followed pump prices in metropolitan areas, and the like. The analysis may include scenario analyses of possible stress events to predict how index and pump prices may move in possible stress events. The analysis may include both historical analyses and scenario analyses. Provider 120 may analyze information received from consumers 110, insurer 140, retail locations 160, and any other source to determine a financial risk associated with selling a price protection product for the commodity. Provider 120 may provide a set of user interfaces through which consumer 110 may access price protection system 120. In some embodiments, such user interfaces may be implemented on a computing device 110 accessible by consumer 110. Consumer 110 can then provide a set of inputs regarding desired price protection to price protection system 120 via the computing device. Provider 120 may store information about one or more consumers 110, retail locations 160, price protection products, insurers 140, analyses, and factors in data store 122.

Provider 120 may generate a price protection product based on the agreement between provider 120 and insurer 140. Provider 190 may generate a price protection product based on its own analysis of market conditions for the commodity. Provider 120 may generate a price protection product based on the inputs provided by a consumer. Under the terms of the price protection product offered to consumer 110, provider 120 may assume more or less risk than insurer 140. Thus, if consumer 110 purchases a commodity under the price protection product when the retail price of the commodity is above the lock price the operators of price protection system 120 may then pay retail point of sale location 160 for the purchased quantity at the prevailing retail price, or some lesser or greater amount. For the quantity of the commodity purchased then, the operators of price protection system 120 may recoup the difference between an insurance strike price and the prevailing retail price at the retail point of sale location at the time of purchase from insurer 140.

Provider 120 may communicate with one or more retail locations 160 and consumers 110 to provide price protection products. Retail locations 160 may be located within a geographic boundary to offer price protection products for consumers 110. Retail locations 160 may also offer the commodity for sale and may gather or obtain information about the sale of the commodity at the location. For example, a retail gasoline location 160 may gather information about the sale of gasoline at that location and communicate the information to provider 120. Provider 120 may then provide price protection products to consumers 110 at location 160 based on the information provided by retail location 160.

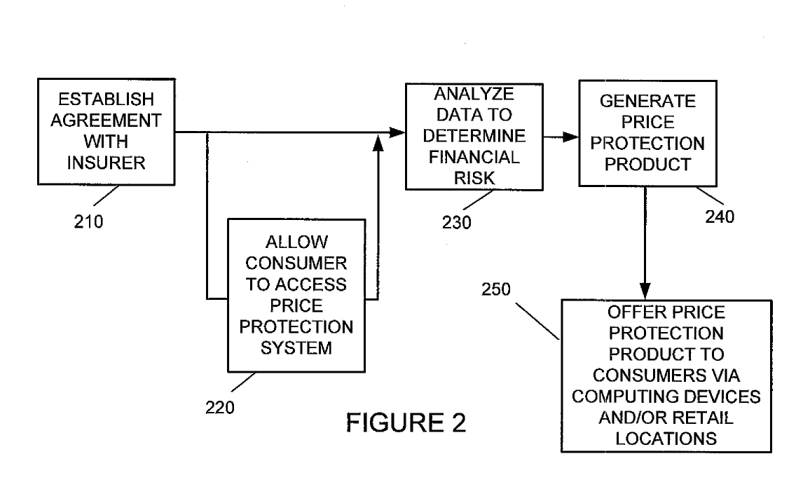

FIG. 2 depicts a flow diagram illustrating one embodiment of a method for providing price protection products to a consumer. At step 210 provider 120 may enter into an agreement with insurer 140. The agreement may have an associated set of terms with an associated financial risk for price protection system 120. In some embodiment, insurer 140 may provide a strike price matrix to price protection system 120. The strike price matrix may comprise a set of price decks. Each price deck may provide a strike price for a designated market area (DMA). A DMA may refer to a city, a zip code; a state; a country, or any other definable geographic region. Each price deck may be associated with a time period, a grade, a quantity, an insurance provider strike price per unit of commodity, and an insurance cost per unit of commodity. In some embodiments, in terms of motor fuels, the insurance cost may be referred to as a hedge cost per gallon (HCPG). In some embodiments, if provider 120 pays insurer 140 the insurance cost, provider 120 may be indemnified against consumers 110 purchasing the commodity at any price above the corresponding insurance strike price in a corresponding price deck, provided that the commodity is of the associated grade, is purchased within the DMA associated with the strike price matrix and within the associated time period. For example, insurer 140 may agree to indemnify provider 120 for 100,000 gallons against the price of 87 unleaded gasoline rising above a strike price of $3.50/gallon in Austin, Tex. for 6 months in exchange for a HCPG of 25 cents.

In some embodiments, under the terms of the agreement between provider 120 and insurer 140, insurer 140 may indemnify provider 120 for any cost above the strike price. In some embodiments, insurer 140 may indemnify provider 120 a percentage of the cost, provide step-wise indemnification, provide sliding-scale indemnification, or otherwise indemnify provider 120 against a portion of the cost. As an example, in terms of motor fuels, the agreement may specify that insurer 140 will indemnify provider 120 for the cost of fuel purchased at $3.50/gallon or higher, or will indemnify provider 120 for 100% of the cost of fuel between $3.50/gallon and $3.75/gallon, 75% of the cost of fuel between $3.75/gallon and $3.85/gallon, and 50% of the cost of fuel purchased at over $3.85/gallon.

In some embodiments, under the terms of an agreement between provider 120 and insurer 140, insurer 140 may promise to indemnify provider 120 for a quantity of a selected commodity. Thus, insurer 140 may limit the financial risk to insurer 140 by limiting the amount of commodity that may be purchased under the terms of the product. Insurer 140 may indemnify provider 120 for a set amount of the commodity. As an example, the agreement may specify that insurer 140 will indemnify provider 120 for up to 1,000,000 gallons of fuel.

In some embodiments, insurer 140 may indemnify provider 120 for a percentage of the commodity. As an example, the agreement may specify that insurer 140 will indemnify provider 120 for 75% of fuel purchased in excess of 1,000,000 gallons of fuel.

In some embodiments, under the terms of an agreement between provider 120 and insurer 140, insurer 140 and provider 120 may agree that purchases under a price protection agreement may be settled against an index price. The settlement terms may include a day on which the settlement occurs, such as the first day of the month, the 15^{th} of the month, etc. The settlement terms may include an index against which the agreement is settled, such as the New York Mercantile Exchange (NYMEX).

In some embodiments, under the terms of an agreement between provider 120 and insurer 140, insurer 140 may indemnify provider 120 for a specified time period. The terms may include a start date and an end date or specify a time period. Thus, provider 120 may determine a first financial risk for providing a price protection product to consumers 110 under the set of terms provided by insurer 140 in an agreement between provider 120 and insurer 140. Those skilled in the art will appreciate that an agreement between insurer 140 and provider 120 may contain other terms and may include other limitations.

In one embodiment, at step 220, provider 120 may allow consumer 110 to access price protection system 120 using computer devices over network 170 as well as by visiting point-of-sale locations 160. Consumer 110 may provide a set of inputs using an interface on a computing device. As an example using motor fuels, the set of inputs may include the type of motor fuel, the quantity, the geographic boundary, the number of vehicles, the number of miles to be driven, the type of vehicles, and the period for which protection is desired. Information received from consumers may include requests for quotes for specialized price protection products. As an example, in terms of fuel, consumer 110 having airplanes and trucks may want a single price protection product that covers both types of fuel. Consumer 110 may have an exceptionally large fleet, or the fleet may operate in different DMAs.

At step 230, provider 120 may analyze data to determine its own estimate of the financial risk associated with the commodity. Provider 120 may analyze market conditions related to the commodity to determine a financial risk associated with a price protection product. One or more analyses may be performed. In some embodiments, provider 120 may perform a historical analysis. In some embodiments, provider 120 may perform a scenario analysis of possible stress events to predict how index and commodity prices may move in possible stress events. A scenario analysis based on predictions of how weather patterns may change may influence provider to expect heating oil prices will be higher than expected by insurer 140. Data may include information relating to consumers 110 or retail locations 160. Based on the analysis of market conditions and the insurance provider strike price matrix, operators of price protection system 120 may determine the amount of risk they wish and/or are able to accept. This determination may be based on the an analysis of any number of factors including a comparison of the terms or constraints of the insurance provider strike price matrix and an analysis of market conditions, or any number of other factors which may be germane to a determination of the level risk acceptance of provider 120. Based on the financial risk determined by provider 120, provider 120 may either lay off or take on more risk. Provider 120 may lay off financial risk through agreements with other financial institutions 140.

Once provider 120 determines a financial risk associated with price protection products for a commodity, a price protection product for consumer 110 may be generated at step 240. The price protection product may comprise a different set of terms than the terms of the agreement between provider 120 and insurer 140. The difference between the set of terms of the price protection product and the set of terms offered by the insurance provider strike price matrix for protection which may be obtained in conjunction with the provisioning of the price protection product or any terms associated with price protection product not defined in conjunction with the insurance provider strike price matrix are determined based on the estimated financial risk determined at step 230.

At step 250, provider 120 may offer one or more price protection products to consumer 110 with a set of terms and an associated level of financial risk. The terms of a price protection product may include delivery terms, which may dictate how much of the commodity consumer 110 can take in any given period. For example, the delivery terms may specify that no more than 20% of the total quantity may be purchased in a month. If consumer 110 purchases a price protection product for 1000 gallons of gasoline for a six-month period, consumer 110 would not be allowed to purchase more than 200 gallons in any month. A price protection product may be offered to consumers 110 through retail locations 160.

The terms of a price protection product may include settlement terms, which may specify that the price protection will be based on an index price such as a price listed on the NYMEX, or may specify some other method for determining the settlement price. In some embodiments, the price may be settled against an aggregate composite price within a geographic boundary, such as disclosed in U.S. patent application Ser. No. 12/030,119, filed Feb. 12, 2008, entitled “System and Method for Determining a Price Within a Geographic Boundary.”

The terms of a price protection product may include a geographic boundary. Thus, consumer 110 living in Boston may purchase a price protection product for a commodity in Boston, and a person in a rural area near Boston may be able to purchase a price protection product for the area near Boston, but the price protection products may not cover the same area. A boundary may be based on a zip code, city limits, state lines, country borders, or some combination or portion thereof.

The terms of a price protection product may include a lock price. In some embodiments, a lock price refers to the price above which consumer 110 is protected by provider 120. The lock price may be the same as the strike price specified in the agreement between provider 120 and insurer 140. The lock price may be higher or lower than the strike price, depending on how much financial risk provider is willing to accept. The lock price may be a percentage, a step-wise increase or decrease in protection, or a sliding scale, independent of whether the agreement between provider 120 and insurer 140 specifies.

Other methods for providing a price protection product may be found in U.S. patent application Ser. No. 11/705,571, filed Feb. 12, 2007 entitled “Method and System for Providing Price Protection for Commodity Purchasing Through Price Protection Contracts” and U.S. patent application Ser. No. 12/030,073, filed Feb. 12, 2008, entitled “System and Method For Generating Revenues In A Retail Commodity Network,” both of which are incorporated by reference.

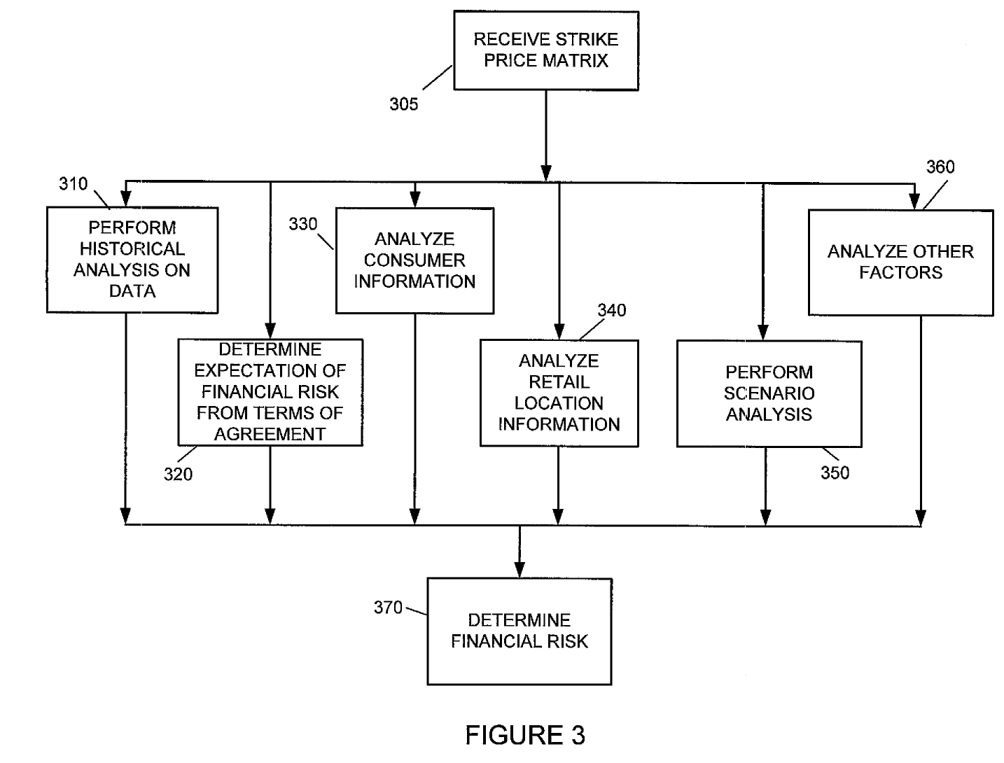

FIG. 3 depicts one embodiment of a flow diagram for determining the financial risk in the provisioning of price protection. A set of index prices may be determined by insurer 140 and these index prices may be used by insurer 140 to determine a strike price matrix, such that the strike price matrix comprises DMAs associated with the index price for the DMA. The strike price matrix may also include a cost associated with each DMA. Thus, provider 120 may pay insurer 140 the cost associated with a DMA and obtain indemnification against the cost of the commodity within that DMA. In step 305, price protection system 120 may receive the strike price matrix from insurer 140. Price protection system 120 may then perform analyses and determine a financial risk associated with offering a consumer the ability to obtain a price protection product where the terms of the price protection product may be changed from those provided to operators of price protection system by insurance provider 140 in the insurance provider strike price matrix.

In step 310, the analysis may include historical analyses, such as how an index price has fluctuated in recent months, what events affect the price of the commodity, how commodity prices have changed in response to local, regional and global events, how closely commodity prices in outlying areas have followed commodity prices in metropolitan areas, and the like. For example, weather can affect the price of heating oil. So, in some embodiments, provider 120 of a carbon-based energy product such as heating fuel may perform a historical analysis on the weather in January in the northeast part of the United States to determine the financial risk associated with providing a price protection product for heating oil to consumers in Boston. The historical analysis of weather in the northeast may influence provider 120 to expect heating oil prices would be lower than that expected by insurer 140. In some embodiments, provider 120 may offer a product for areas other than the DMAs specified in the agreement between provider 120 and insurer 140. In these embodiments, provider 120 may perform a historical analysis on how closely prices in outlying areas have followed commodity prices in metropolitan areas may influence provider 120 to expect the price of heating oil in areas surrounding Boston to be less volatile than those in Boston. Provider 120 may determine a higher or lower financial risk than the risk offered under the agreement with insurer 140 based on historical events.

At step 320, provider 120 may analyze data to determine an expectation for the price of a commodity based on any of the terms in the agreement between provider 120 and insurer 140. For example, provider 120 may analyze market conditions for a given DMA based on the type of commodity, the quantity, and a time period. In other embodiments, provider 120 may analyze market conditions on terms other than what are in the agreement between provider 120 and insurer 140. For example, provider 120 may analyze market conditions at the zip code level and the agreement between provider 120 and insurer 140 may be based on market conditions studied at the state level. Provider 120 may analyze market conditions weekly and insurer 140 may analyze market conditions monthly. Provider 120 may analyze market conditions based on settling the price against an aggregate price computed from transactions that occurred within a geographic boundary, and insurer 140 may analyze market conditions to determine an index price for settling. The analysis may include both historical analysis and scenario analysis. Provider may analyze information received from consumers 110 accessing price protection system 120 via computing devices to estimate a market condition that could affect the price of the commodity. Thus, provider 120 may determine a financial risk for a commodity based on broader or narrower terms than what is found in the agreement between provider 120 and insurer 140.

At step 330, provider 120 may analyze information relating to consumers 110. The information may be provided by consumers 110 accessing price protection system 120 via computing devices. The information may include past transactions, the quantity of the commodity consumed in other periods, the average price paid by consumer 110 in relation to other consumers 110 during the same time period, etc.

At step 340, provider 120 may analyze information relating to retail locations 160. The information may be provided by retail locations 160. The information may include the quantity of the commodity sold at location 160 in relation to other locations 160, the average price at which location 160 sold the commodity as compared to other locations 160, the storage capacity of location 160, etc.

At step 350, price protection system 120 may perform scenario analyses of possible stress events. As an example, the price of retail gasoline may continue to rise. A scenario analysis of various stress events may be more reliable than a historical analysis of some events.

At step 360, price protection system 120 may further analyze other factors, such as the forward markets for the commodity, the current average retail price of the commodity; the ability of operators of price protection system 120 to generate revenue from any of a variety of sources, impending regulatory legislation, etc. For example, data received from sales of price protection products at retail locations 160 may be analyzed to determine a financial risk. Data received from consumers 110 accessing price protection system 120 via computing devices may be analyzed to determine a financial risk.

At step 370, price protection system 120 may compare the different analyses, weight them, or otherwise determine a financial risk for the commodity based on an analysis or analyses of data.

It may be helpful to an understanding of embodiments disclosed herein to illustrate specific examples of the altering (i.e., changing or adding terms) of terms in the provisioning of a price protection product to accept more or less risk based on the indemnification options offered to the providers of price protection products.

In one embodiment, the terms pertaining to price or time period may be altered to accept risk. For example, suppose insurance strike price matrix states offers protection against an insurance strike price of $2.50 per gallon in the Austin DMA for 6 months for a HCPG of 25 cents. In this case, price protection system may offer a price protection product to a consumer offering price protection in the Austin DMA for 6 months at a lock price of $2.45 per gallon for the purchase price of $2.75 per gallon. If the consumer obtains this price protection product for a specified amount of fuel the operators of price protection system may obtain indemnification for the same amount of fuel from insurance provider 140 according to the insurance strike price of $2.50 per gallon in the Austin DMA for 6 months for a HCPG of 25 cents. Here the operators of price protection system 120 have accepted 0.05 cents of risk on the amount of fuel on which price protection was obtained by the consumer. Similarly, price protection system 120 may offer a price protection product to consumer 110 offering price protection in the Austin DMA for 7 months at a lock price of $2.50 per gallon for the purchase price of $2.75 per gallon. If consumer 110 obtains this price protection product for a specified amount of fuel the operators of price protection system 120 may obtain indemnification for the same amount of fuel from insurance provider 140 according to the insurance strike price of $2.50 per gallon in the Austin DMA for 6 months for a HCPG of 25 cents. Here the operators of price protection system 120 have accepted the risk that the price will be above the $2.50 per gallon lock price for the additional month of the price protection product relative to the indemnification obtained from insurance provider 140.

In some embodiments, providers of price protection may change the manner in which the settlement of a provided price protection product is performed. To illustrate, suppose insurance strike price matrix states offers protection against an insurance strike price of $2.50 per gallon in the Austin DMA for 6 months for a HCPG of 25 cents, where the indemnification from the insurance provider 140 to operators of price protection system 120 is to be determined according to an index price (e.g. the difference between the index price and the insurance strike price) as discussed above. In this case, price protection system 120 may offer a price protection product to consumer 110 offering price protection in the Austin DMA for 6 months at a lock price of $2.50 per gallon for the purchase price of $2.75 per gallon. Any transactions under this price protection product may be settled against the retail price at the retail point of location where the transaction occurs. If consumer 110 obtains this price protection product for a selected amount of fuel the operators of price protection system 120 may obtain indemnification for the same amount of fuel from insurance provider 140 according to the insurance strike price of $2.50 per gallon in the Austin DMA for 6 months for a HCPG of 25 cents where the indemnification is determined with respect to the index price. Here the providers of price protection 120 have assumed the risk of any difference between the retail price at the retail point of sale location where fuel is purchased and the index price at the time of the transaction.

In some embodiments, providers of price protection may add terms to a price protection product which place constraints on a consumer's exercise of their rights under the product. To illustrate, suppose insurance strike price matrix states offers protection against an insurance strike price of $2.50 per gallon in the Austin DMA for 6 months for a HCPG of 25 cents. In this case, price protection system may offer a price protection product to a consumer offering price protection in the Austin DMA for 6 months at a lock price of $2.50 per gallon for the purchase price of $2.75 per gallon where the consumer may only deplete 20% of the amount of fuel purchased under the price protection product in a given month. If the consumer obtains this price protection product for a certain amount of fuel the operators of price protection system 120 may obtain indemnification for the same amount of fuel from insurance provider 140 according to the insurance strike price of $2.50 per gallon in the Austin DMA for 6 months for a HCPG of 25 cents where the indemnification is determined with respect to the index price. Here the providers of price protection product 120 accepted less risk by placing these constraints on the exercise of the price protection product by consumer 110. If consumer 110 exceeds the depletion constraint consumer 110 may be responsible for the purchase of any amount of fuel exceeding this constraint at the then prevailing retail price at the point of sale location. For example, suppose that a consumer purchases 120 gallons of fuel under the example price protection product discussed above with a 30% per month depletion constraint. Suppose now that in the first month after obtaining the price protection product the consumer purchases 44 gallons of fuel above the lock price of the price protection product. In this example, the operators of price protection system 120 may pay the retail point of sale location where the fuel was purchased for 36 gallons under the price protection product and the 44 gallons may be depleted from the consumer' virtual reserve. The consumer, however, may be responsible for paying the then prevailing retail price at the retail point of sale location for the 8 gallons that exceeded the terms of the price protection product. This amount, for example, may be billed through to a credit card associated with the consumer's account.

It will be noted that the above descriptions and examples are for illustrative purposes only and that terms may be changed, added, or otherwise altered to take on or lay off risk in almost any manner imaginable, and that almost any alteration of terms in the provisioning of a price protection product for the purchase of a commodity will be encompassed by the scope of embodiments of the invention disclosed herein.

In the foregoing specification; the invention has been described with reference to specific embodiments. However, one of ordinary skill in the art will appreciate that various modifications and changes can be made without departing from the spirit and scope of the invention disclosed herein.

Accordingly, the specification and figures disclosed herein are to be regarded in an illustrative rather than a restrictive sense, and all such modifications are intended to be included within the scope of the invention.

What is claimed is.:

1. A method comprising:
establishing an agreement for a commodity, wherein the agreement has a first set of terms and an associated first financial risk;
analyzing market conditions for the commodity to determine a second financial risk associated with the commodity for the provider of the price protection product;
comparing the terms of the agreement to the analysis of the market conditions; and
generating a price protection product having a second set of terms based on the first set of terms and the comparison of the first set of terms to the analysis of the market conditions, wherein the second set of terms has an associated third financial risk.

2. The method of claim 1, wherein the first set of terms comprises one or more of designated market area (DMA), quantity, length of the agreement, expiration date of the agreement, price per unit, hedge cost per unit, delivery terms, commodity definitions, and settling terms.

3. The method of claim 2, wherein settling terms comprises designating an index-based settlement.

4. The method of claim 2, wherein delivery terms comprises specifying a minimum or maximum quantity of the commodity that may be consumed in a time period.

5. The method of claim 2, wherein the commodity definitions comprises a carbon-based energy product.

6. The method of claim 5, wherein a carbon-based energy product comprises motor fuel, heating oil, aviation fuel, or emission credit.

7. The method of claim 1, wherein analyzing market conditions for the commodity to determine a second financial risk associated with the commodity for the provider of the price protection product comprises determining a composite aggregated price for the commodity within a geographic boundary.

8. The method of claim 7, wherein analyzing market conditions for the commodity to determine a second financial risk associated with the commodity for the provider of the price protection product comprises determining the ability to generate revenue from other sources related to the commodity.

9. The method of claim 1, wherein generating a price protection product having a second set of terms based on the first set of terms and the comparison of the first set of terms to the analysis of the market conditions comprises increasing the financial risk to the provider of the price protection product.

10. The method of claim 1, wherein generating a price protection product having a second set of terms based on the first set of terms and the comparison of the first set of terms to the analysis of the market conditions comprises decreasing the financial risk to the provider of the price protection product.

11. The method of claim 1, wherein the second set of terms comprises one or more of a designated market area (DMA), quantity, time period, commodity standards, settling terms, and delivery terms.

12. A system for managing risk in the provisioning of price protection products, comprising:
an insurance provider for establishing an agreement to accept a first financial risk associated with the cost of a commodity, wherein the insurance provider accepts the first financial risk according to a first set of terms in exchange for a first price;
a price protection operable to:
obtain insurance associated with the commodity from the insurance provider in exchange for the first price;
analyze market conditions for the commodity to determine a second financial risk associated with the commodity for the provider of the price protection product;
compare the terms of the agreement to the analysis of the market conditions; and
generate a price protection product having a second set of terms based on the first set of terms and the comparison of the first set of terms to the analysis of the market conditions, wherein the second set of terms has an associated third financial risk.

13. The system of claim 12, wherein the first set of terms comprises one or more of designated market area (DMA), quantity, length of the agreement, expiration date of the agreement, price per unit, hedge cost per unit, delivery terms, commodity definitions, and settling terms.

14. The system of claim 13, wherein settling terms comprises designating an index-based settlement.

15. The system of claim 13, wherein delivery terms comprises specifying a minimum or maximum quantity of the commodity that may be consumed in a time period.

16. The system of claim 13, wherein the commodity definitions comprises a carbon-based energy product.

17. The system of claim 16, wherein a carbon-based energy product comprises motor fuel, heating oil, aviation fuel, or emission credit.

18. The system of claim 12, wherein analyzing market conditions for the commodity to determine a second financial risk associated with the commodity for the provider of the price protection product comprises determining a composite aggregated price for the commodity within a geographic boundary.

19. The system of claim 18, wherein analyzing market conditions for the commodity to determine a second financial risk associated with the commodity for the provider of the price protection product comprises determining the ability to generate revenue from other sources related to the commodity.

20. The system of claim 12, wherein generating a price protection product having a second set of terms based on the first set of terms and the comparison of the first set of terms to the analysis of the market conditions comprises increasing the financial risk to the provider of the price protection product.

21. The system of claim 12, wherein generating a price protection product having a second set of terms based on the first set of terms and the comparison of the first set of terms to the analysis of the market conditions comprises decreasing the financial risk to the provider of the price protection product.

22. The system of claim 12, wherein the second set of terms comprises one or more of a designated market area (DMA), quantity, time period, commodity standards, settling terms, and delivery terms.

23. The system of claim 13, wherein the index comprises NYMEX.
